(19) United States
(12) Patent Application Publication
(10) Pub. No.: US 2001/0055666 A1
(43) Pub. Date: Dec. 27, 2001

(54) Flexible magnetic strip

(76) Inventors: Simon J. Lee, Sheffield (GB); Michael E. Burton, Sheffield (GB)

Correspondence Address: RICHARD A. GIANGIORGI, ESQ., TREXLER, BUSHNELL,GIANGIORGI,, BLACKSTONE & MARR, 105 WEST ADAMS, 36th FLOOR, CHICAGO, IL, 60603, US

(21) Appl. No.: 09/876,326

(22) Filed: Jun. 7, 2001

(30) Foreign Application Priority Data
Jun. 9, 2000 (GB) 0013965.9

(51) Int. Cl. B32B 3/30

(52) U.S. Cl. 428/156; 428/343

(57) ABSTRACT

For holding together flexible materials, such as roll-up display screens, edge-to-edge, very thin and narrow flexible magnetic strip (3) is co-moulded edge-to-edge with non-magnetic flexible strip (4), one face (7 or 5) of the combined strip (1 or 2) being suitable for the application of an adhesive, e.g. in the form of double-adhesive tape (8, 9), and the other face (5 or 7) being provided with indicator means for the polarity of the magnetic portions (3) e.g. different colouring pigments in the non-magnetic portions (4) of co-acting combined strips, or impressions such as a single continuous groove (6) for N-polarity and a pair of grooves (10) for S-polarity.

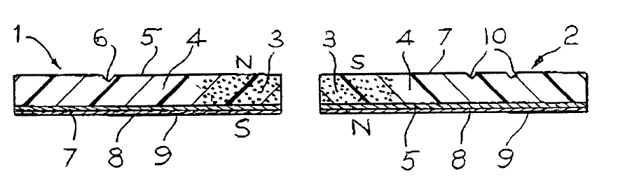

This invention relates to flexible magnetic strip, more particularly of the type having such attraction and holding power that comparatively very thin and narrow strips (e.g. width of the order of 3.0 mm and thickness of the order of 1.0 mm) can attract edge-to-edge.

While it is evident that such flexible magnetic strips would be useful in many applications where both flexibility and holding power are of great advantage, e.g., in releasably holding together flexible materials, such as roll-up display screens, edge-to-edge, the problem is how to secure the strips to the flexible materials without creating too much stiffness and identifying the relevant polarity

The object of the present invention is to provide a solution to these problems.

According to the present invention, very thin and narrow flexible magnetic strip is co-moulded edge-to-edge with non-magnetic flexible strip, one face of the combined strip is suitable for the application of an adhesive, and the other face is provided with indicator means for the polarity of the magnetic portion. The non-magnetic strip may be of greater width than the magnetic strip, an example of a suitable width of non-magnetic strip being 5.0 mm.

The adhesive may be one side of double-adhesive tape applied to the co-moulded strip subsequent to extrusion from the mould.

The indicator means may comprise colouring pigment in the non-magnetic portion of the co-moulded strip distinct from the colour of the magnetic portion: and different colours can be used to indicate the different polarities of co-acting strips. Alternatively, the indicator means may comprise impressions in the non-magnetic portion of the co-moulded strip, such as a continuous groove or grooves formed during extrusion, for example, a single groove for N-polarity and a pair of grooves for S-polarity.

Co-acting embodiments of the invention will now be described, by way of example only, with reference to the accompanying drawing which is a greatly enlarged diagrammatic cross-section (not to scale) through co-acting strips.

The drawing shows two strips 1, 2 each co-moulded with a narrower portion 3 of flexible magnetic material and a wider portion 4 of non-magnetic flexible material. One face 5 of the portion 4 of strip 1 has a single groove 6 in it to identify its N-polarity, and the other face 7 carries double-adhesive tape 8 whereby the strip 1 can be adhered to one side of, say, a roll-up display screen (not shown) after removal of a releasable cover strip 9. The other strip 2, on the other hand, has two grooves 10 in its face 7 to identify its S-polarity, and its face 5 carries double-adhesive tape 8 whereby the strip 2 can be adhered to one side of, say, another roll-up display screen (also not shown) after removal of its releasable cover strip 9, thus enabling the two strips 1, 2 to be used to hold together edge-to-edge the two screens.

Alternatively, as mentioned above, identification of the polarities of the strips 1, 2 may be effected by incorporating different colour pigments in their respective wider portions 4: but the advantage in using grooves 6, 10 lies in being able to use a non-coloured binder such as that used in the magnetic portion of the co-moulding.

1. Very thin and narrow flexible magnetic strip co-moulded edge-to-edge with non-magnetic flexible strip, one face of the combined strip being suitable for the application of an adhesive, and the other face being provided with indicator means for the polarity of the magnetic portion.

2. Co-moulded magnetic and non-magnetic flexible strips as in claim 1, wherein the non-magnetic strip is of greater width than the magnetic strip.

3. Co-moulded magnetic and non-magnetic flexible strips as in claim 1 or claim 2, wherein the adhesive is one side of double-adhesive tape applied to the co-moulded strip subsequent to extrusion from the mould.

4. Co-moulded magnetic and non-magnetic flexible strips as in claim 1, wherein the indicator means comprises colouring pigment in the non-magnetic portion of the co-moulded strip distinct from the colour of the magnetic portion.

5. Co-moulded magnetic and non-magnetic flexible strips as in claim 4, wherein different colours are used to indicate the different polarities of co-acting strips.

6. Co-moulded magnetic and non-magnetic flexible strips as in claim 1, wherein the indicator means comprises impressions in the non-magnetic portion of the co-moulded strip.

7. Co-moulded magnetic and non-magnetic flexible strips as in claim 6, wherein the indicator means comprises a continuous groove or grooves formed during extrusion,

8. Co-moulded magnetic and non-magnetic flexible strips as in claim 7 with a single groove for N-polarity and a pair of grooves for S-polarity.
